(19) United States
(12) Patent Application Publication
(10) Pub. No.: US 2025/0105451 A1
(43) Pub. Date: Mar. 27, 2025

(54) SOLID ELECTROLYTE MEMBRANE, PREPARATION METHOD THEREOF, AND ALL SOLID RECHARGEABLE BATTERIES

(71) Applicant: SAMSUNG SDI CO., LTD., Yongin-si (KR)

(72) Inventors: Mijung JUNG, Yongin-si (KR); Seonhyeok AN, Yongin-si (KR); Seunghyun OH, Yongin-si (KR)

(21) Appl. No.: 18/830,654

(22) Filed: Sep. 11, 2024

(30) Foreign Application Priority Data
Sep. 25, 2023 (KR) 10-2023-0128381

(51) Int. Cl. H01M 50/457; H01M 10/0525; H01M 10/0562; H01M 50/403; H01M 50/411

(52) U.S. Cl. CPC H01M 50/457; H01M 10/0562; H01M 50/403; H01M 50/411; H01M 10/0525

(57) ABSTRACT

A solid electrolyte membrane includes a first layer including solid electrolyte particles; a second layer on the first layer, the second layer including a composite; and a third layer on the second layer, the third layer including solid electrolyte particles, wherein the composite includes a diamagnetic core particle, and a shell surrounding the diamagnetic core particle, the shell including a solid electrolyte material.

### CROSS-REFERENCE TO RELATED APPLICATION

This application claims priority to and the benefit of Korean Patent Application No. 10-2023-0128381 filed in the Korean Intellectual Property Office on Sep. 25, 2023, the entire contents of which are incorporated herein by reference.

### BACKGROUND

### 1. Field

Embodiments relate to solid electrolyte membranes, methods of manufacturing the same, and all-solid-state rechargeable batteries.

### 2. Description of the Related Art

Recently, development of batteries with high energy density and safety has been actively being made in response to industrial demands. Lithium ion batteries have been available in the automobile fields as well as the information-related device and communication device fields.

### SUMMARY

The embodiments may be realized by providing a solid electrolyte membrane including a first layer including solid electrolyte particles; a second layer on the first layer, the second layer including a composite; and a third layer on the second layer, the third layer including solid electrolyte particles, wherein the composite comprises a diamagnetic core particle, and a shell surrounding the diamagnetic core particle, the shell comprising a solid electrolyte material.

The diamagnetic core particle may have an aspect ratio greater than 1, as calculated by Equation 1:

$$aspect ratio = major axis length / minor axis length . \qquad [ Equation 1 ]$$

A major axis of the composite may be arranged at about 50° to about 130° with respect to a plane direction of the solid electrolyte membrane.

The composite may include the diamagnetic core particle and the shell at a weight ratio of about 1:1 to about 1:500.

The diamagnetic core particle may be needle-shaped, plate-shaped, or oval-shaped.

The diamagnetic core particle may include a carbon material, the carbon material including artificial graphite, natural graphite, graphene, a carbon nanotube, a carbon fiber, carbon black, or a combination thereof.

The shell may include a sulfide solid electrolyte, an oxide solid electrolyte, a halide solid electrolyte, or a combination thereof.

The composite may satisfy one or more of Equations 2 and 3:

$$0.1 \leq {A}_{1} / B \leq 100 \qquad [ Equation 2 ]$$

$$0.01 \leq {A}_{2} / B \leq 10 \qquad [ Equation 3 ]$$

in Equations 2 and 3, A₁ may represent a major axis length of the diamagnetic core particle, A₂ may represent a minor axis length of the diamagnetic core particle, and B may represent a thickness of the shell.

The second layer may further include solid electrolyte particles.

A content of the solid electrolyte particle in the second layer may be about 50 wt % to about 99.9 wt %, based on a total weight of the second layer.

A major axis length of the diamagnetic core particle may be about 1 μm to about 50 μm, and a minor axis length of the diamagnetic core particle may be about 10 nm to about 5 μm.

The composite may be included in the second layer in an amount of about 0.1 wt % to about 50 wt %, based on a total weight of the second layer.

An average thickness of the first layer may be about 10 μm to about 200 μm, and an average thickness of the third layer may be about 10 μm to about 200 μm.

An average thickness of the second layer may be greater than an average thickness of the first layer, and the average thickness of the second layer may be greater than an average thickness of the third layer.

An average thickness of the second layer may be in a range of about 1.2 times to about 5 times an average thickness of the first layer, and the average thickness of the second layer may be in a range of about 1.2 times to about 5 times an average thickness of the third layer.

An average thickness of the first layer may be about 10 μm to about 34 μm, an average thickness of the second layer may be about 35 μm to about 100 μm, and an average thickness of the third layer may be about 10 μm to about 34 μm.

The second layer may further include a binder, and the binder may be included in the second layer in an amount of about 0.1 wt % to about 3 wt %, based on a total weight of the second layer.

The solid electrolyte particles may include sulfide solid electrolyte particles.

The embodiments may be realized by providing a method of preparing a solid electrolyte membrane, the method including forming a first layer including solid electrolyte particles, forming a second layer on the first layer such that the second layer includes a composite, and forming a third layer on the second layer such that the third layer includes solid electrolyte particles, wherein the composite includes a diamagnetic core particle, and a shell surrounding the diamagnetic core particle, the shell including a solid electrolyte.

Forming the second layer may include preparing the composite such that the composite comprises the diamagnetic core particle; and the shell surrounding the diamagnetic core particle and including a solid electrolyte, preparing a slurry for forming the second layer comprising the composite, and coating the slurry for forming the second layer on the first layer.

The method may further include applying a magnetic field to the slurry for forming the second layer coated on the first layer.

The method may further include drying the slurry for forming the second layer after the magnetic field has been applied.

Preparing the composite may include mixing the diamagnetic core particle, the solid electrolyte, and a first solvent to prepare a mixed solution, drying the mixed solution to form a dried product, and heat-treating the dried product.

Preparing the slurry for forming the second layer may include mixing the composite and a second solvent.

A magnetic field strength may be about 0.1 T to about 3 T.

An application time of the magnetic field may be about 0.1 second to about 10 minutes.

The method may further include drying the first layer; drying the second layer; drying the third layer; and drying a stack of the first layer, the second layer, and the third layer after drying the third layer, wherein a drying temperature for drying the stack may be higher than a drying temperature for drying each of the first layer, second layer, and third layer.

Drying the stack may be performed at about 70° C. to about 120° C.

The embodiments may be realized by providing an all-solid-state rechargeable battery including a positive electrode layer; a negative electrode layer; and the solid electrolyte membrane according to an embodiment between the positive electrode layer and the negative electrode layer.

The negative electrode layer may include a negative electrode current collector; and a negative electrode coating layer on the negative electrode current collector and including a lithophilic metal, a carbon material, or a combination thereof, and a lithium metal layer may be formed by charging between the negative electrode current collector and the negative electrode coating layer.

### BRIEF DESCRIPTION OF THE DRAWINGS

Features will be apparent to those of skill in the art by describing in detail exemplary embodiments with reference to the attached drawings in which:

FIG. 1 is a schematic diagram of a composite according to some embodiments.

FIG. 2 is a schematic diagram of a solid electrolyte membrane according to some embodiments.

FIG. 3 is a schematic diagram of a movement path of lithium ions in a solid electrolyte membrane that does not include a composite.

FIG. 4 is a schematic diagram of a movement path of lithium ions in a second layer according to some embodiments.

FIG. 5 is a schematic perspective view of the solid electrolyte membrane according to some embodiments.

FIG. 6 is a schematic cross-sectional view of the second layer in the solid electrolyte membrane according to some embodiments.

FIGS. 7 and 8 are schematic cross-sectional views of the all-solid-state rechargeable battery according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In addition, it will also be understood that when a layer is referred to as being “between” two layers, it can be the only layer between the two layers, or one or more intervening layers may also be present. As used herein, the term “or” is not necessarily an exclusive term, e.g., “A or B” would include A, B, or A and B.

Hereinafter, embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a stack, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” includes not only a shape formed on the whole surface when viewed from a plan view, but also a shape formed on a partial surface.

“Particle diameter” or “average particle diameter” may be measured by a method well known to those skilled in the art, for example may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. An average particle diameter may mean a diameter (D50) of particles having a cumulative volume of 50 volume % in a particle size distribution.

“Thickness” may be measured through photographs taken with an optical microscope, for example a scanning electron microscope.

### Solid Electrolyte Membrane

In some embodiments, a solid electrolyte membrane may include a first layer including solid electrolyte particles; a second layer on the first layer and including a composite; and a third layer on the second layer and including solid electrolyte particles. In an implementation, the composite may include a core including diamagnetic particles (e.g., a diamagnetic core particle); and a shell surrounding the core and including a solid electrolyte.

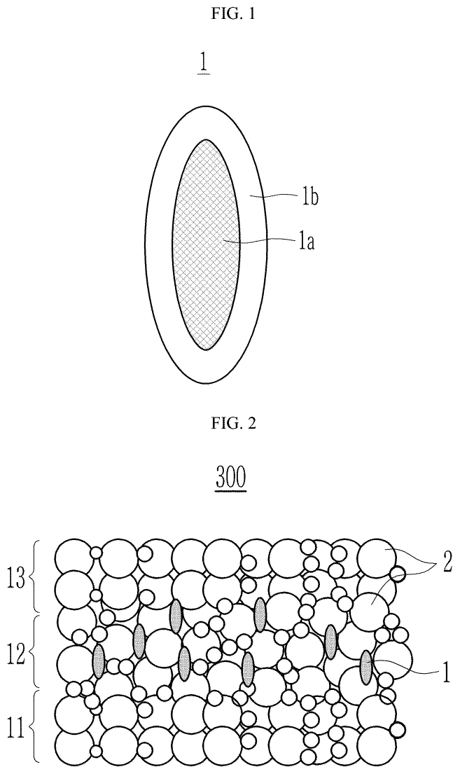

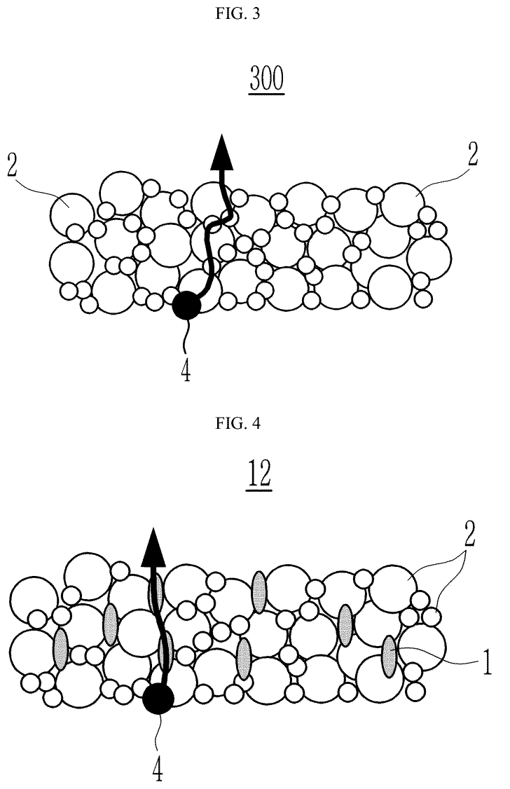

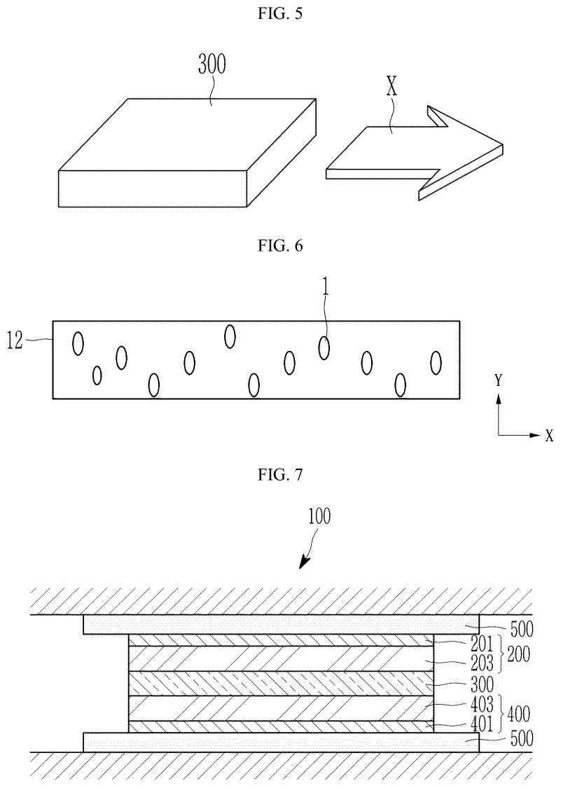

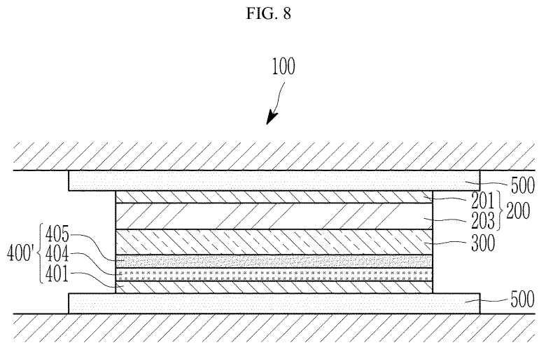

FIG. 1 is a schematic view of a composite 1 included in a second layer 12 in a solid electrolyte membrane 300 according to some embodiments and FIG. 2 is a schematic view of the solid electrolyte membrane 300 according to some embodiments. In addition, FIG. 3 is a schematic view of a movement path of lithium ions in a solid electrolyte membrane that does not include a composite, and FIG. 4 is a schematic view of the lithium ion movement path in the second layer 12 according to some embodiments. FIG. 5 is a schematic perspective view of the solid electrolyte membrane 300 according to some embodiments and FIG. 6 is a schematic cross-sectional view of the second layer 12 in the solid electrolyte membrane 300 according to some embodiments. FIGS. 7 to 8 are schematic cross-sectional views of the all-solid-state rechargeable battery 100 according to some embodiments.

All-solid-state rechargeable batteries may use no flammable organic dispersive medium, and even if a short circuit were to occur, may greatly reduce possibility of the fire or explosion but thus greatly increase safety, compared with lithium ion batteries (e.g., that include a liquid electrolyte). A solid electrolyte may have lower lithium ionic conductivity than a liquid electrolyte. In order to shorten an ion movement path in an electrode plate of the all-solid-state rechargeable batteries, there may be a method of forming holes or pores to fill the solid electrolyte therein or adding an additive increasing the lithium ionic conductivity. However, in the case of a method of forming holes or pores and filling the interior with a solid electrolyte, there may be a limit to filling the interior thereof with the solid electrolyte without any gaps. The method of adding the additive increasing ionic conductivity could also cause a side reaction between the solid electrolyte and the additive or could affect properties of slurry for forming an electrode layer and thus may limit the selection of the additive.

In order to shorten the lithium ion movement path in the solid electrolyte membrane, a composite including diamagnetic particles in the core and a solid electrolyte in the shell, wherein the solid electrolyte itself has a core-shell structure, may be included in the solid electrolyte membrane. The composite having the core including diamagnetic particles itself may have electrical conductivity, and if it were to be used for the solid electrolyte membrane as it is, there could be a risk of internal short circuit of a cell.

Accordingly, some embodiments provide a solid electrolyte membrane that can shorten the movement path of lithium ions while suppressing the possibility of internal short circuit of the cell.

In order to improve ionic conductivity and high rate capability by shortening the movement path of lithium ions, the composite 1 shown in FIG. 1 may be used as a material for or in the solid electrolyte membrane. In order to shorten the movement path of lithium ions, the composite 1 may have a core-shell structure having a core 1a including diamagnetic particles and a shell 1b surrounding the core and including a solid electrolyte. As shown in FIG. 4, lithium ions 4 may have a shorter movement path by moving through the composite 1, thereby improving ionic conductivity and high rate capability. In comparison, as shown in FIG. 3, if the composite were not included in the solid electrolyte membrane, the movement path of the lithium ions could be longer, compared to that of FIG. 4, resulting in lower ionic conductivity.

In an implementation, the composite 1 may be used, and it may be necessary to reduce the risk of internal short circuit of the cell that could otherwise occur due to the inclusion of diamagnetic particles as the core 1a. For this purpose, as shown in FIG. 2, a first layer 11 including solid electrolyte particles and a third layer 13 including solid electrolyte particles may be stacked on the upper and lower surfaces or sides of the second layer 12, respectively, so that the layer containing the composite 1 may be in the middle and thus the solid electrolyte membrane 300 may be a triple layer.

In an implementation, in order to help further improve the ionic conductivity and high rate capability of the all-solid-state rechargeable battery, the composite 1 itself may be non-spherical within the second layer 12 of the solid electrolyte membrane. In an implementation, the composite 1 may be non-spherical within the second layer 12 and at the same time, the composite may be aligned in a direction perpendicular to or close to the perpendicular direction with respect to the plane direction of the solid electrolyte membrane.

In some methods of forming a solid electrolyte membrane by coating a slurry for forming a solid electrolyte membrane including a non-spherical composite onto a substrate, the non-spherical composite could be randomly distributed in the second layer. In order to align the non-spherical composite 1 in the second layer 12 in a direction perpendicular to or close to the perpendicular direction with respect to the plane direction of the solid electrolyte membrane 300, a method of applying a magnetic field after coating a slurry for forming a second layer including a non-spherical composite onto a substrate may be considered.

The alignment of the non-spherical composite may be controlled by the magnetic field because the non-spherical composite has diamagnetic properties. In an implementation, as shown in FIG. 1, a composite 1 having a core 1a including non-spherical diamagnetic particles may be used, and thus the alignment of the composite 1 within the solid electrolyte membrane 300 can be controlled. In an implementation, the composite 1 may be aligned in the second layer 12 in a direction perpendicular to or close to the perpendicular direction with respect to the plane direction of the solid electrolyte membrane 300, the movement path of lithium ions within the solid electrolyte membrane may be shortened, and the interfacial contact resistance between solid electrolytes may be reduced. In an implementation, the all-solid-state rechargeable battery 100 including the solid electrolyte membrane 300 according to some embodiments may have improved ionic conductivity and high rate capability.

Hereinafter, elements constituting the solid electrolyte membrane 300 according to some embodiments will be described in more detail.

### Composite

The composite 1 may have a core 1a-shell 1b structure and as shown in FIG. 1, the composite 1 may include the core 1a including diamagnetic particles; and a shell 1b surrounding the core 1a and including a solid electrolyte.

In an implementation, in the composite 1, the core 1a (or the diamagnetic particle included in the core) may be non-spherical. In an implementation, the composite 1 may have an aspect ratio (as represented or calculated by Equation 1) of greater than 1.

$$A spect ratio = major axis length / minor axis length \qquad [ Equation 1 ]$$

Such non-spherical diamagnetic particles and the composite 1 including the same may be aligned in a perpendicular direction or close to the perpendicular direction to a plane direction of the solid electrolyte membrane (e.g., at about 50° to about 130° with respect to the plane direction of the solid electrolyte membrane 300) by a magnetic field externally applied thereto. In an implementation, the plane direction X of the solid electrolyte membrane 300 may represent a parallel direction to the surface of a wide side of the solid electrolyte membrane. FIG. 5 shows a perspective view of the solid electrolyte membrane 300 and the plane direction X of the solid electrolyte membrane 300. In addition, FIG. 6 shows a cross-sectional view of the second layer 12 included in the solid electrolyte membrane 300, and the plane direction (X) of the solid electrolyte membrane 300 and the direction (Y) perpendicular to the plane direction (X) are shown as lines, respectively.

In an implementation, the aspect ratio (as calculated by Equation 1) may increase, and the performance of the all-solid-state rechargeable battery including the solid electrolyte membrane may be improved. In an implementation, an aspect ratio represented by Equation 1 may be greater than or equal to about 1.1, greater than or equal to about 1.2, greater than or equal to about 1.3, greater than or equal to about 1.5, greater than or equal to about 2, or greater than or equal to about 3. An upper limit of the aspect ratio (as calculated by Equation 1) may be less than or equal to about 5,000, less than or equal to about 300, less than or equal to about 100, less than or equal to about 50, less than or equal to about 20, or less than or equal to about 10, considering convenience and cost savings in the manufacturing process. In an implementation, an aspect ratio of the core 1a may be about 1.1 to about 20 or about 1.5 to about 10.

In an implementation, a major axis length of the composite 1 may be about 1 μm to about 50 μm or a minor axis length of the composite 1 may be about 0.01 μm to about 5 μm. In an implementation, an aspect ratio expressed by Equation 1, which is the ratio of the major axis length to the minor axis length of the composite 1, may be greater than 1. Herein, the major axis length and the minor axis length of the composite mean average values.

In an implementation, in the composite 1, the shell 1b may have a uniform thickness or may be non-uniform.

In an implementation, the composite 1 may satisfy one or both of Equations 2 and 3, below. In an implementation, Equation 2 may be satisfied, Equation 3 may be satisfied, or both Equations 2 and 3 may be satisfied. In such a case, the alignment effect of the core 1a of the composite 1 and the lithium ion conduction effect of the shell 1b may be harmonized. Herein, in Equations 2 and 3, the units of the numerator and denominator need only match each other, so that the units of A₁, A₂, and B are not limited.

$$0.1 \leq {A}_{1} / B \leq 100 \qquad [ Equation 2 ]$$

$$0.01 \leq {A}_{2} / B \leq 10 \qquad [ Equation 3 ]$$

In Equations 2 and 3, A₁ represents the major axis length of the core 1a, A₂ represents the minor axis length of the core 1a, and B represents a thickness of the shell 1b.

In an implementation, the major axis length of the core 1a may be about 1 μm to about 50 μm, about 1 μm to about 20 μm, about 2 μm to about 15 μm, or about 3 μm to about 12 μm. In an implementation, the minor axis length of the core 1a may be about 10 nm to about 5 μm, about 100 nm to about 5 μm, or about 1 μm to about 4 μm. In an implementation, the thickness of the shell 1b may be about 100 nm to about 10 μm, about 100 nm to about 5 μm, or about 300 nm to about 3 μm. Within these ranges, an alignment effect by the core 1a and the lithium ionic conduction effect by the shell 1c may be harmonized. In an implementation, the major axis length of the core 1a, the minor axis length of the core 1a, and the thickness of the shell 1b mean average values. A method of measuring the major axis length of the core 1a, the minor axis length of the core 1a, and the thickness of the shell 1b may include, e.g., cutting the solid electrolyte membrane to obtain a cross-section specimen, as shown in FIG. 6, and capturing its image with a scanning electron microscope (SEM) to examine the composite 1 in the second layer 12 of the solid electrolyte membrane 300. In an implementation, the major axis length of the core 1a, the minor axis length of the core 1a, and the thickness of the shell 1 may be obtained by measuring ten (e.g., randomly selected) composites 1 in one cross-section specimen and calculate each average value thereof.

In an implementation, in the composite 1, a weight ratio of the core 1a and the shell 1b may be about 1:1 to about 1:500, about 1:2 to about 1:100, about 1:10 to about 1:50. Within these ranges, an alignment effect by the core 1a and the lithium ion conduction effect by the shell 1b may be harmonized.

In an implementation, the major axis length of the composite 1 in the solid electrolyte membrane 300 may be aligned in a perpendicular direction (Y) or close to the perpendicular direction (Y) to a plane direction (X) of the solid electrolyte membrane 300. As shown in FIG. 6, the alignment angle of the major axis length of the composite 1 with the plane direction (X) of the solid electrolyte membrane 300 may be obtained, with reference to the cross-section of the solid electrolyte membrane 300 (or the second layer 12), by measuring an angle of the major axis length of the composite 1, which is indicated by a line, with the plane direction (X) of the solid electrolyte membrane (or the second layer 12).

In an implementation, the major axis of the composite 1 in the solid electrolyte membrane 300 may be aligned with an angle ranging from about 50° to about 130° with the plane direction (X) of the solid electrolyte membrane 300, e.g., from about 70° to about 110°, or about 85° to about 95° or with a substantially perpendicular angle of about 90°, which is a direction (Y). Within these ranges, the lithium ion movement path in the solid electrolyte membrane may be effectively shortened, and interfacial contact resistance among the solid electrolyte may be reduced.

In the composite 1, the diamagnetic particles of the core 1a may have a non-spherical shape with an aspect ratio of greater than 1 satisfying Equation 1. In an implementation, the core 1a may include diamagnetic particles that are, e.g., needle-shaped, sheet-shaped, or oval-shaped. In an implementation, the core 1a may include a carbon material, e.g., artificial graphite, natural graphite, graphene, carbon nanotubes (CNT), carbon fiber, carbon black, or a combination thereof as diamagnetic particles. In an implementation, the carbon nanotubes (CNTs) may be S-carbon nanotubes (Short length CNTs) or L-carbon nanotubes (Long length CNTs).

In an implementation, the shell 1b may include a suitable solid electrolyte material. In an implementation, the shell 1b may include a sulfide solid electrolyte, an oxide solid electrolyte, a halide solid electrolyte, or a combination thereof. In an implementation, the solid electrolyte included in the shell 1b may include the sulfide solid electrolyte and the shell 1b of the composite 1 may include Li₆PS₅Cl, e.g., a type of argyrodite-type sulfide solid electrolyte. In an implementation, the description of the solid electrolyte particles in the first layer 11, the second layer 12, and the third layer 13 may be applied in the same way as the solid electrolyte usable in the shell 1b.

A content of the composite 1 may be about 0.1 wt % to about 50 wt %, about 0.5 wt % to about 40 wt %, about 1 wt % to about 30 wt %, or about 5 wt % to about 25 wt %, based on a total weight of the second layer 12. Within these ranges, the effect of improving ionic conductivity and high rate characteristics according to the composite 1 may be further enhanced.

The solid electrolyte membrane 300 according to some embodiments, e.g., in order to reduce possibility of internal short circuit of the cell, as shown in FIG. 2, may include the first layer 11 including the solid electrolyte particles 2; the second layer 12 on the first layer 11 and including the composite 1; and the third layer 13 on the second layer 12 and including the solid electrolyte particles 2. In an implementation, a triple layer may include the composite 1 having the core including the diamagnetic particles capable of having electrical conductivity in the second layer 12, an intermediate layer, resultantly securing safety of the cell battery.

### First Layer and Third Layer

The first layer 11 and the third layer 13 may each include the solid electrolyte particles 2. The first layer 11 and the third layer 13 may include the solid electrolyte particles 2 to help secure ionic conductivity of the solid electrolyte membrane. In an implementation, the first layer 11 and the third layer 13, unlike the second layer 12, may not include the composite 1, and thus may help suppress an internal short circuit that could otherwise be caused by the composite 1 included in the second layer 12.

The solid electrolyte particles 2, which may be included in the first layer 11 and the third layer 13, may include a suitable solid electrolyte, e.g., a sulfide solid electrolyte, an oxide solid electrolyte, a halide solid electrolyte, or a combination thereof.

Hereinafter, the solid electrolyte particles 2 included in the first layer 11 and the third layer 13 are described in detail.

### Sulfide Solid Electrolyte

In an implementation, the sulfide solid electrolyte may include Li₂S—P₂S₅, Li₂S—P₂S₅—LiX(X is a halogen element, for example 1, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer and Z is Ge, Zn, or Ga), Li₂S—GeS₂, Li₂S—SiS₂—Li₃PO₄, Li₂S—SiS₂—LiₚMO_{q} (p and q are integers and M is P, Si, Ge, B, Al, Ga, or In), or a combination thereof.

In an implementation, the sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling is a method of mixing the starting materials into fine particles by placing them in a ball mill reactor and agitating them strongly. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments may be, e.g., prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ionic conductivity and high performance can be obtained, and such a solid electrolyte may be suitable for mass production. A temperature of the first heat treatment may be, e.g., about 150° C. to about 330° C. or about 200° C. to about 300° C. and a temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10-4 to about 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte membrane. An all-solid-state rechargeable battery including the same may have improved battery performance such as rate capability, coulombic efficiency, and cycle-life characteristics.

In an implementation, the argyrodite-type sulfide solid electrolyte particle may include, e.g., a compound represented by Chemical Formula 11.

(LiₐM¹_{b}M²_{c})(P_{d}M³ₑ)(S_{f}M⁴_{g})Xₕ [Chemical Formula11]

In Chemical Formula 11, 4≤a≤8, M¹ may be Mg, Cu, Ag, or a combination thereof, 0≤b<0.5, M² may be Na, K, or a combination thereof, 0≤c≤0.5, M³ may be Sₙ, Zn, Si, Sb, Ge, or a combination thereof, 0<d<4, 0≤e<1, M⁴ may be O, SOₙ, or a combination thereof, 1.5≤n≤5, 33≤f≤12, 0≤g<2, X may be F, Cl, Br, I, or a combination thereof, and 0≤h≤2.

In an implementation, in Chemical Formula 11, a halide element (X) may be necessarily included, and in this case, it may be expressed as 0<h≤2. In an implementation, M¹ element may be necessarily included in Chemical Formula 11, and in this case, it may be expressed as 0<b<0.5. In Chemical Formula 11, M³ may be understood as an element substituted for P and may be 0<e<1. In Chemical Formula 11, M⁴ is substituted for S and, e.g., may be 0<g<2, and f, a ratio of S, may be, e.g., 3≤f≤7. In an implementation, M⁴ may be SOₙ, and SOₙ may be, e.g., S₄O₆, S₃O₆, S₂O₃, S₂O₄, S₂O₅, S₂O₆, S₂O₇, S₂O₈, SO₄, SO₅, or SO₄.

In an implementation, in Chemical Formula 11, a+b+c+h=7, d+e=1, and f+g+h=6.

In an implementation, the argyrodite-type sulfide solid electrolyte particles may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06}) PS_{4.75}Cl_{1.25}, (Li_{5.72}Cu_{0.03}) PS_{4.75}Cl_{1.25}, (Li_{5.69}CU_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}CU_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., two or more heat treatment processes. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particle may be, e.g., about 0.1 μm to about 5.0 μm, about 0.1 μm to about 3.0 μm, small particles of about 0.1 μm to about 1.9 μm, or large particles of about 2.0 μm to about 5.0 μm. In an implementation, the sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, e.g., a particle size distribution may be obtained by measuring the size (diameter or major axis length) of about 20 particles in a scanning electron microscope image, and D₅₀ may be calculated therefrom.

### Oxide Solid Electrolyte

The oxide solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti) O₃ (PZT), Pb₁₋ₓ LaₓZr_{1-y}Ti_{y}O₃ (PLZT) (0≤x<1, 0≤y<1), PB(Mg₃Nb_{2/3}) O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} (PO₄)₃, 0<x<2, 0<y<3), Li_{1+x+y} (Al, Ga) x (Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; x is an integer of 1 to 10), or a mixture thereof.

### Halide Solid Electrolyte

The solid electrolyte membrane may include, e.g., the halide solid electrolyte.

The halide solid electrolyte may contain a halogen element as a main component, meaning that the ratio of the halide element to all elements constituting the solid electrolyte may be greater than or equal to about 50 mol %, greater than or equal to about 70 mol %, greater than or equal to about 90 mol %, or 100 mol %. In an implementation, the halide solid electrolyte may not contain a sulfur element.

The halide solid electrolyte may contain a lithium element, metal element other than lithium, and the halogen element. The metal element other than lithium may be, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, e.g., may be Cl, Br, or a combination thereof. The halide solid electrolyte may be represented by, e.g., LiₐM₁X₆ (M is Al, As, B, Bi, Ca, Cd, Co, Cr, Fe, Ga, Hf, In, Mg, Mn, Ni, Sb, Sc, Sₙ, Ta, Ti, Y, Zn, Zr, or a combination thereof and X is F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

In an implementation, the solid electrolyte particles included in the first layer 11 and the third layer 13 may be the same or different from each other. In an implementation, the solid electrolyte particles 2 included in the first layer 11 and the third layer 13 may be the same or different from the solid electrolyte included in the shell 1b of the composite 1. In an implementation, the shell 1b of the composite 1 may be composed of Li₆PS₅Cl and solid electrolyte particles included in the first layer 11 and the third layer 13 may be composed of Li₆PS₅Cl.

In an implementation, the first layer 11 and the third layer 13 may each independently further include a binder as an optional component, in addition to the aforementioned solid electrolyte particles or may further include other components such as an alkali metal salt, an ionic liquid, or a conductive polymer. Hereinafter, the components that may be additionally included in the first layer 11 and the third layer 13 are described in detail.

### Binder

In an implementation, the first layer 11 and the third layer 13 may further include the binder. The binder may help adhere the solid electrolyte particles 2 to each other within the first layer 11 or the third layer 13. Such a binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoro propylene copolymer, polyvinyl chloride, carboxylated polyvinyl chloride, polyvinyl fluoride, polyethylene, a polypropylene, an ethylene-propylene copolymer, an ethylene-propylene-diene copolymer, polyamideimide, polyimide, an acrylic resin, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt % or about 0.5 wt % to about 1.5 wt %, based on a total weight of the first layer 11 or the third layer 13. Within these ranges, the components in the solid electrolyte membrane may be well combined without reducing the ionic conductivity of the solid electrolyte, thereby improving durability and reliability of the battery.

### Other Components

In an implementation, the first layer 11 and the third layer 13 may each further include one or more other components, e.g., alkali metal salts, ionic liquids, or conductive polymers as optional components.

In an implementation, the alkali metal salt may be a lithium salt. The concentration of the lithium salt in the solid electrolyte layer may be greater than or equal to about 1 M, e.g., about 1 M to about 4 M. In this case, the lithium salt may help improve ionic conductivity by improving lithium ion mobility in the solid electrolyte layer. The lithium salt may include, e.g., LiPF₆, LiBF₄, LiSbF₆, LiAsF₆, LiClO₄, LiAlO₂, LiAlCl₄, LiPO₂F₂, LiCl, LiI, LiSCN, LIN(CN)₂, lithium bis(oxalato) borate (LiBOB), lithium difluoro (oxalato) borate (LiDFOB), lithium difluorobis(oxalato)phosphate (LiDFBP), lithium bis(trifluoromethane sulfonyl)imide (LiTFSI), lithium bis(fluoro) sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may include an imide lithium salt such as LiTFSI, LiFSI, LiBETI, or a combination thereof. The imide lithium salt may help maintain or improve ionic conductivity by maintaining appropriate chemical reactivity with ionic liquids.

The ionic liquid has a melting point below room temperature, so it is in a liquid state at room temperature and refers to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂) (CF₃SO₂)N—, or (CF₃SO₂)₂N—.

The ionic liquid may include, e.g., N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

The first layer 11 and the third layer 13 may each have a weight ratio of solid electrolyte particles and the ionic liquid of about 0.1:99.9 to about 90:10, e.g., about 10:90 to about 90:10, about 20:80 to about 90:10, about 30:70 to about 90:10, about 40:60 to about 90:10, or about 50:50 to about 90:10. Within the above ranges, the electrochemical contact area with the electrode may be improved and ionic conductivity may be maintained or improved. Accordingly, the energy density, discharge capacity, rate characteristics, etc. of the all-solid-state rechargeable battery may be improved.

In an implementation, an average thickness of the first layer 11 may be the same as or different from an average thickness of the third layer 13. In an implementation, an average thickness of the first layer 11 and the third layer 13 may each independently be about 10 μm to about 200 μm, e.g., about 10 μm to about 150 μm, about 10 μm to about 100 μm, about 10 μm to about 60 μm, about 10 μm to about 50 μm, about 10 μm to about 34 μm, about 13 μm to about 34 μm, about 15 μm to about 34 μm, or about 20 μm to about 34 μm.

### Second Layer

As shown in FIG. 2, the second layer 12 may be between the first layer 11 and the third layer 13 and the second layer 12 may include the composite 1 described above. By including the composite 1 on or in the second layer 12, which is an intermediate layer, an internal short circuit of the cell may be suppressed and safety of the battery may be ensured. In an implementation, the second layer 12 may further include the solid electrolyte particles 2 in addition to the aforementioned composite 1 described above.

The description of the solid electrolyte particles that may be included in the second layer 12 may be applied in the same way as the solid electrolyte particles in the shell 1b of the aforementioned composite 1 and the solid electrolyte particles in the first layer 11 and the third layer 13.

In an implementation, the solid electrolyte particles 2 included in the second layer 12 may be the same as or different from the solid electrolyte included in the shell 1b of the composite 1, and solid electrolyte particles included in one or more of the first layer 11 and the third layer 13.

In an implementation, the shell 1b of the composite 1 may be made of Li₆PS₅Cl and the solid electrolyte particles included in the second layer 12 may be made of Li₆PS₅Cl. In an implementation, the solid electrolyte particles included in the first layer 11 and the third layer 13 may be composed of Li₆PS₅Cl and the solid electrolyte particles included in the second layer 12 may be composed of Li₆PS₅Cl.

In an implementation, the second layer 12 may further include the aforementioned binder as an optional component or may further include other components, e.g., an alkali metal salt, an ionic liquid, or a conductive polymer. In an implementation, the contents described above with respect to the first layer 11 and the third layer 13 may be equally applicable to the binder and other components.

In an implementation, a content of the binder included in the second layer 12 may be about 0.1 wt % to about 3 wt %, e.g., about 0.5 wt % to about 2 wt %, or about 0.5 wt % to about 1.5 wt %, based on a total weight of the second layer 12. Within these ranges, the components in the second layer 12 may be well combined without lowering the ionic conductivity of the solid electrolyte, and thus the durability and reliability of the battery may be improved.

In an implementation, a content of the solid electrolyte particles 2 included in the second layer 12 (e.g., excluding the solid electrolyte included in the shell 1b of the composite 1) may be about 50 wt % to about 99.9 wt %, e.g., about 60 wt % to about 99.9 wt %, about 65 wt % to about 99.5 wt %, about 70 wt % to about 98 wt %, or about 75 wt % to about 97 wt %, based on a total weight of the second layer 12.

In an implementation, an average thickness of the second layer 12 may be the same as or different from an average thickness of one or more of the first layer 11 and the third layer 13. In an implementation, an average thickness of the second layer 12 may be greater than an average thickness of the first layer 11 and greater than an average thickness of the third layer 13. In an implementation, an average thickness of the second layer 12 may be in the range of about 1.2 times to about 5 times, about 1.3 times to about 4.8 times, about 1.5 times to about 4.5 times, or about 1.8 times to about 4 times an average thickness of each of the first layer 11 and the third layer 13. In an implementation, an average thickness of the second layer 12 may be about 10 μm to about 200 μm, e.g., about 10 μm to about 150 μm, about 10 μm to about 100 μm, about 20 μm to about 100 μm, about 35 μm to about 100 μm, about 40 μm to about 90 μm, or about 50 μm to about 80 μm. Within these ranges, ionic conductivity due to the composite 1 included in the second layer 12 may be effectively secured.

In an implementation, an average thickness of the first layer 11 and the third layer 13 may each independently be about 10 μm to about 34 μm, respectively, and an average thickness of the second layer 12 may be about 35 μm to about 100 μm.

### Manufacturing Method of Solid Electrolyte Membrane

Some embodiments may provide a method of manufacturing the solid electrolyte membrane, which may include forming a first layer including solid electrolyte particles, forming a second layer including a composite on the first layer, forming a third layer including solid electrolyte particles on the second layer. The composite may include a core including diamagnetic particles; and a shell surrounding the core and including a solid electrolyte.

The aforementioned description is about the method of manufacturing the solid electrolyte membrane according to some embodiments, and hereinafter, repeated descriptions overlapping with that of the solid electrolyte membrane 300 may be omitted, and processes of manufacturing the solid electrolyte membrane according to some embodiments will be further described.

The formation of the second layer 12 may include manufacturing the composite 1, preparing a slurry for forming the second layer 12 including the composite, and applying the slurry for forming the second layer 12 onto the first layer 11. The slurry for forming the second layer 12 may further include the solid electrolyte particles 2 in addition to the composite 1, and the description of the solid electrolyte particles includable in the slurry for forming the second layer 12 may be equally applied herein and may not be repeated.

The slurry for forming the second layer 12 may be prepared by mixing the composite 1 and a second solvent. The second solvent may include a suitable solvent capable of dispersing the composite 1. In an implementation, the second solvent may include octyl acetate, isobutyl isobutyrate, xylene, toluene, benzene, hexane, or a combination thereof.

In an implementation, the slurry for forming the first layer 11 may further include solid electrolyte particles 2, a binder, an alkali metal salt, ionic liquid, or a conductive polymer, which have previously been described as components that can be included in the second layer 12. In an implementation, suitable dispersants (e.g., H-NBR, etc.) may be further added.

The aforementioned slurry for forming the second layer 12 may be coated on the first layer 11, and at this time, a suitable method may be used as an application method. In an implementation, methods such as bar coating, spin coating, die coating, transfer coating, and spray coating may be used.

After coating the slurry for forming the aforementioned second layer, drying the applied slurry for forming the second layer may be performed. In an implementation, the drying may be performed in a convection oven, and the drying temperature may be about 30° C. to about 100° C., about 35° C. to about 95° C., about 40° C. to about 90° C., about 45° C. to about 80° C., about 48° C. to about 75° C., or about 50° C. to about 70° C. In an implementation, the drying may be performed for about 10 seconds to about 20 minutes, about 30 seconds to about 15 minutes, about 1 minute to about 10 minutes, or about 2 minutes to about 8 minutes.

In an implementation, the method may further include applying a magnetic field to the slurry for forming the second layer 12, having been applied on any one of the first layer 11 and the third layer 13. In an implementation, the composite 1, which has been randomly distributed in the second layer 12, may have an alignment in which it is aligned in a direction perpendicular (Y) or close to the perpendicular direction (Y) with respect to the plane direction (X) of the solid electrolyte membrane 300.

In an implementation, the magnetic field strength may be about 0.1 T (Tesla) to about 3 T or about 0.5 T to about 2 T. In an implementation, the application time of the magnetic field may be about 0.1 seconds to about 10 minutes, about 30 seconds to about 8 minutes, or about 1 minute to about 5 minutes. In an implementation temperature at which the magnetic field may be a suitable temperature, and the higher the temperature, the weaker the magnetic field strength may be. The strength and the application time of the magnetic field may be appropriately controlled to effectively secure alignment of the composite 1 in the second layer 12.

After applying the magnetic field, the slurry for forming the second layer 12, to which the magnetic field has been applied, may be dried. Through the drying, the second layer 12 may be formed on the first layer 11 or the third layer 13. In an implementation, the drying may be performed in a convection oven, and the drying temperature may be about 30° C. to about 100° C., about 35° C. to about 95° C., about 40° C. to about 90° C., about 45° C. to about 80° C., about 48° C. to about 75° C., or about 50° C. to about 70° C. In an implementation, the drying may be performed for about 10 seconds to about 20 minutes, about 30 seconds to about 15 minutes, about 1 minute to about 10 minutes, or about 2 minutes to about 8 minutes. Within these ranges, appropriate alignment of the composite 1 within the second layer 12 may be effectively secured.

In an implementation, after drying the slurry for forming the second layer 12 to which a magnetic field has been applied to form the second layer 12 on the first layer 11, the second layer 12 may be subsequently further compressed, and the drying, the compression, and the like may be performed under suitable conditions.

In an implementation, it may further include removing the substrate as needed after application of the magnetic field.

In an implementation, the composite 1 may be manufactured by preparing a mixed solution including the diamagnetic particles, the solid electrolyte particles, and a first solvent, drying the mixed solution, and heat-treating the dried product.

In an implementation, during preparation of the composite 1, an addition ratio of the diamagnetic particles and the solid electrolyte particles may be about 1:1 to about 1:500, about 1:2 to about 1:100, or about 1:10 to about 1:50, e.g., by weight.

The first solvent may be a suitable solvent capable of dispersing the diamagnetic particles and the solid electrolyte particles. In an implementation, acetonitrile may be used.

In an implementation, drying of the applied slurry for forming the first layer may be performed at about 80° C. to about 150° C., about 90° C. to about 140° C., or about 100° C. to about 130° C. In an implementation, the heat treatment may be performed at about 200° C. to about 600° C., about 250° C. to about 550° C., about 300° C. to about 500° C., or about 350° C. to about 450° C. Within these ranges, the composite 1 in which the alignment effect of the core 1a and the lithium ion conduction effect of the shell 1b are harmonized may be effectively manufactured.

The first layer 11 may be formed by preparing a slurry for forming the first layer 11 including solid electrolyte particles and a solvent and then coating it on the substrate or the already formed second layer 12. In an implementation, a suitable solvent that can disperse the solid electrolyte particles 2 may be used, e.g., octyl acetate. In an implementation, a suitable method for coating the slurry for forming the second layer may be used. In an implementation, methods such as bar coating, spin coating, die coating, transfer coating, and spray coating may be used.

After coating the slurry for forming the first layer, the coated slurry for forming the first layer may be dried to form the first layer. In an implementation, the drying may be performed in a convection oven and the drying temperature may be about 30° C. to about 100° C., or about 35° C. to about 95° C., about 40° C. to about 90° C., about 45° C. to about 80° C., about 48° C. to about 75° C., or about 50° C. to about 70° C. In an implementation, the drying may be performed for about 10 seconds to about 20 minutes, about 30 seconds to about 15 minutes, about 1 minute to about 10 minutes, or about 2 minutes to about 8 minutes. Within these ranges, an appropriate alignment of the composite 1 within the second layer 12 may be effectively secured.

In an implementation, after drying the slurry for forming the first layer, rolling the first layer may be further included. In an implementation, the rolling conditions may be suitable conditions.

In an implementation, a substrate may be used in forming the first layer, and removing the substrate may be further performed.

In an implementation, the slurry for forming the first layer 11 may further include, e.g., a binder, an alkali metal salt, ionic liquid, or a conductive polymer previously mentioned as components that can be included in the second layer 12. In an implementation, a suitable dispersant (e.g., H-NBR, etc.) may be added.

The third layer 13 may be formed by preparing a slurry for forming the third layer 13 (including solid electrolyte particles and a solvent) and then coating it on the substrate or the already formed second layer 12. In an implementation, the solvent may include a suitable solvent that can disperse the solid electrolyte particles 2, e.g., octyl acetate.

After coating the slurry for forming the third layer, the coated slurry for forming the third layer may be dried to form the third layer. In an implementation, the drying may be performed in a convection oven. The drying temperature may be about 30° C. to about 100° C., about 35° C. to about 95° C., about 40° C. to about 90° C., about 45° C. to about 80° C., about 48° C. to about 75° C., or about 50° C. to about 70° C. In an implementation, the drying may be performed for about 10 seconds to about 20 minutes, about 30 seconds to about 15 minutes, about 1 minute to about 10 minutes, or about 2 minutes to about 8 minutes.

In an implementation, it may further include drying the aforementioned slurry for forming the third layer to form the third layer 13 on the second layer 12, and then compressing the third layer 13, and the compressing conditions may be suitable conditions.

In an implementation, a substrate may be used in forming the third layer, and removing the substrate may be further performed.

In an implementation, the slurry for forming the third layer 13 may further include, e.g., a binder, an alkali metal salt, ionic liquid, or a conductive polymer previously mentioned as components that can be included in the second layer 12. In an implementation, a suitable dispersant (e.g., H-NBR, etc.) may be added.

In an implementation, after forming the aforementioned third layer, the method may further include drying a stack of the first layer, the second layer, and the third layer. In an implementation, drying of the stack may be performed in a vacuum oven. In an implementation, the drying temperature for the aforementioned stack may be higher than the drying temperature for each of the aforementioned first layer, the second layer, and the third layer. In an implementation, the drying temperature for the stack may be about 50° C. to about 150° C., about 60° C. to about 130° C., about 70° C. to about 120° C., or about 80° C. to about 100° C. In an implementation, the drying time for the stack may be about 30 minutes to about 10 hours, about 40 minutes to about 8 hours, or about 1 hour to about 5 hours. Within these ranges, the solid electrolyte membrane 300 in which the first layer, second layer, and third layer are stacked may be effectively manufactured.

All-solid-state Rechargeable Battery

In an implementation, an all-solid-state rechargeable battery including a positive electrode layer; a negative electrode layer; and the aforementioned solid electrolyte membrane between the positive electrode layer and the negative electrode layer may be provided. The all-solid-state rechargeable battery may include the solid electrolyte membrane according to the aforementioned embodiment, and it may ensure the safety of the battery by effectively suppressing internal short circuit of the cell while exhibiting excellent ionic conductivity and high rate capability.

Hereinafter, repeated descriptions that overlap with the above may be omitted, and the components of an all-solid-state rechargeable battery according to some embodiments, will be described in more detail with reference to FIGS. 7 and 8.

The all-solid-state rechargeable battery may be expressed as an all-solid-state battery or an all-solid rechargeable lithium battery.

FIG. 7 is a cross-sectional view of an all-solid-state battery according to some embodiments. Referring to FIG. 7, the all-solid-state battery 100 may include an electrode assembly in which a negative electrode layer 400 including a negative electrode current collector 401 and a negative electrode active material layer 403, a solid electrolyte membrane 300, and a positive electrode layer 200 including a positive electrode current collector 201 and a positive electrode active material layer 203 are stacked in a case such as a pouch. In an implementation, the all-solid-state battery 100 may further include an elastic layer 500 outside at least one of the positive electrode layer 200 and the negative electrode layer 400. In an implementation, as illustrated in FIG. 7, one electrode assembly may include a negative electrode layer 400, a solid electrolyte membrane 300, and a positive electrode layer 200, or an all-solid-state battery may be manufactured by stacking two or more electrode assemblies.

### Positive Electrode Layer

The positive electrode layer may include, e.g., the positive electrode current collector 201 and the positive electrode active material layer 203 on the positive electrode current collector 201.

The positive electrode current collector 201 may include an aluminum foil, a nickel foil, a stainless steel foil, a titanium foil, nickel foam, copper foam, a polymer substrate coated with a conductive metal, or a combination thereof. In an implementation, the aluminum foil may be used as the positive electrode current collector.

The positive electrode active material layer 203 may further include positive electrode active material, and may optionally include the solid electrolyte, the binder or conductive material.

### Positive Electrode Active Material

As the positive electrode active material, a compound capable of reversible intercalation and deintercalation of lithium (lithiated intercalation compound) may be used. In an implementation, a composite oxide of a metal, e.g., cobalt, manganese, nickel, or a combination thereof, and lithium may be used.

The composite oxide may be a lithium transition metal composite oxide and examples may include lithium nickel oxide, lithium cobalt oxide, lithium manganese oxide, lithium iron phosphate compound, cobalt-free nickel-manganese oxide, lithium-excessive layered oxide, or a combination thereof. In an implementation, the positive electrode active material may be a high nickel positive electrode active material having a nickel content of greater than or equal to about 80 mol % based on 100 mol % of a metal excluding lithium in the lithium transition metal composite oxide. The content of nickel in the high nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of a metal excluding lithium. The high-nickel positive electrode active materials can achieve high capacity and may be applied to high-capacity, high-density rechargeable lithium batteries.

In an implementation, a compound represented by one of the following chemical formulas may be used. LiₐA_{1-b}X_{b}O₂-D′_{c} (0.90≤a≤1.8,0<b≤0.5,0≤c≤0.05); LiₐMn_{2-b}X_{b}O_{4-c}D′_{c} (0.90≤a≤1.8, 0≤b≤0.5, 0≤c≤0.05); LiₐNi_{1-b-c}CO_{b}X^{c}O₂₋ₐD′ₐ (0.90≤a≤1.8, 0≤b≤0.5, 0≤c≤0.5, 0<a<2); LiₐNi_{1-b-c}Mn_{b}X_{c}O₂₋ₐD′ₐ (0.90≤a≤1.8, 0≤b≤0.5, 0≤c≤0.5, 0<a<2);LiₐNi_{b}Co_{c}L¹_{d}GₑO₂ (0.90≤a≤1.8,0≤b≤0.9,0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8)

In the above chemical formulas, A is Ni, Co, Mn, or a combination thereof; X is Al, Ni, Co, Mn, Cr, Fe, Mg, Sr, V, a rare earth element, or a combination thereof; D′ is O, F, S, P, or a combination thereof; G is Al, Cr, Mn, Fe, Mg, La, Ce, Sr, V, or a combination thereof; and L¹ is Mn, Al, or a combination thereof.

The positive electrode active material may include, e.g., a lithium nickel oxide represented by Chemical Formula 21, a lithium cobalt oxide represented by Chemical Formula 22, a lithium iron phosphate compound represented by Chemical Formula 23, a cobalt-free lithium nickel-manganese oxide represented by Chemical Formula 24, or a combination thereof.

Liₐ₁Niₓ₁M¹_{y1}M²_{z1}O_{2-b1}X_{b1} [Chemical Formula 21]

In Chemical Formula 21, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² may each independently be Al, B, Ba, Ca, Ce, Co, Cr, Cu, Fe, Mg, Mn, Mo, Nb, Si, Sn, Sr, Ti, V, W, or Zr, and X may be F, P, or S.

In Chemical Formula 21, 0.6≤x1≤1, 0≤y1≤0.4, and 0≤z1≤0.4 or 0.8≤x1≤1, 0≤y1≤0.2, and 0≤z1≤0.2.

Liₐ₂Coₓ₂M³_{y2}O_{2-b2}X_{b2} [Chemical Formula 22]

In Chemical Formula 22, 0.9≤a2≤1.8, 0.7≤x2≤1, 0≤y2≤0.3, 0.9≤x2+y2≤1.1, and 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula 23]

In Chemical Formula 23, 0.9≤a3≤1.8, 0.6≤x3≤1, 0≤y3≤0.4, 0≤b3≤0.1, M⁴ may be Al, B, Ba, Ca, Ce, Co, Cr, Cu, Mg, Mn, Mo, Ni, Se, Si, Sₙ, Sr, Ti, V, W, Y, Zn, or Zr, and X may be F, P, or S.

Liₐ₄Niₓ₄Mn_{y4}M⁵_{z4}O_{2-b4}X_{b4} [Chemical Formula 24]

In Chemical Formula 24, 0.9≤a2≤1.8, 0.8≤x4≤1, 0≤y4≤0.2, 0≤z4≤0.2, 0.9≤x4+y4+z4≤1.1, 0≤b4≤0.1, M⁵ may be Al, B, Ba, Ca, Ce, Cr, Fe, Mg, Mo, Nb, Si, Sn, Sr, Ti, V, W, or Zr, and X may be F, P, or S.

An average particle diameter (D₅₀) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D₅₀) of about 1 μm to about 9 μm and large particles having an average particle diameter (D₅₀) of about 10 μm to about 25 μm. The positive electrode active material having these particle size ranges may be harmoniously mixed with other components within the positive electrode active material layer and may achieve high capacity and high energy density. Herein, the average particle diameter means a diameter (D₅₀) of particles having a cumulative volume of 50 volume % in the particle size distribution that is obtained by measuring the size (diameter or major axis length) of 20 particles at random in a scanning electron microscope image for positive electrode active materials.

The positive electrode active material may be in the form of secondary particles made by agglomerating a plurality of primary particles or in the form of single particles. In an implementation, the positive electrode active material may have a spherical or close to spherical shape, or may have a polyhedral or irregular shape.

In an implementation, the positive electrode active material may include a buffer layer on the particle surface. The buffer layer may be expressed as a coating layer, a protective layer, etc., and may serve to lower the interfacial resistance between the positive electrode active material and the sulfide-based solid electrolyte particles. In an implementation, the buffer layer may include a lithium-metal-oxide, and the metal may include Al, B, Ca, Ce, Cr, Fe, Mg, Mo, Nb, Si, Sn, Sr, Ta, V, W, or Zr. The lithium-metal-oxide may help improve the performance of the positive electrode active material by facilitating the movement of lithium ions and electronic conduction, and may help lower the interfacial resistance between the positive electrode active material and solid electrolyte particles.

In an implementation, the positive electrode active material may be included in an amount of about 55 wt % to about 99.5 wt %, e.g., about 65 wt % to about 95 wt %, or about 75 wt % to about 91 wt %, based on a total weight of the positive electrode active material layer.

### Binder

The binder may help adhere the positive electrode active material particles to each other and also to help adhere the positive electrode active material to the positive electrode current collector 201. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, a (meth)acrylated styrene-butadiene rubber, polyacrylonitrile, polymethyl methacrylate, a vinylidene fluoride/hexafluoropropylene copolymer, an epoxy resin, a (meth)acrylic resin, a polyester resin, and nylon.

### Conductive Material

The conductive material may help provide electrode conductivity and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum, silver, or the like; a conductive polymer such as a polyphenylene derivative; or a mixture thereof.

A content of the binder and the conductive material may each independently be about 0.1 wt % to about 10 wt % or about 0.1 wt % to about 5 wt %, based on a total weight of the positive electrode active material layer 203.

The positive electrode active material layer 203 may further include an additive, e.g., fillers, coating agents, dispersants, or ionic conductivity auxiliary agents in addition to the positive electrode active material, the binder, and the conductive material.

### Solid Electrolyte

In an implementation, the positive electrode active material layer 203 may selectively include the solid electrolyte. The solid electrolyte may include, e.g., a sulfide solid electrolyte, an oxide solid electrolyte, a halide solid electrolyte, or a combination thereof, and the specific descriptions thereof may be the same as the above descriptions in the solid electrolyte membrane 300. In an implementation, the positive electrode active material layer 203 may further include a sulfide solid electrolyte, and the ionic conductivity of the positive electrode layer can be further improved.

The solid electrolyte included in the positive electrode active material layer 203 may be applied in the same way as the solid electrolyte included in the shell 1b of the aforementioned composite 1, or the solid electrolyte particles included in the first to third layers 11 to 13 in the aforementioned solid electrolyte membrane 300.

The solid electrolyte included in the positive electrode active material layer 203 may be the same as the solid electrolyte included in the shell 1b of the aforementioned composite 1 or solid electrolyte particles included in the first layer 11 to the third layer 13. In an implementation, the shell 1b of the composite 1 may be composed of Li₆PS₅Cl, and the sulfide solid electrolyte included in the positive electrode active material layer 203 may also be composed of Li₆PS₅Cl.

In the positive electrode active material layer 203, a content of the solid electrolyte may be about 0.5 wt % to about 30 wt %, e.g., about 1 wt % to about 5 wt % based on a total weight of the positive electrode active material layer 203. Including the solid electrolyte in the positive electrode active material layer 203 within these amounts may help ensure that the efficiency and cycle-life characteristics of the all-solid-state rechargeable battery may be improved without reducing the capacity.

### Negative Electrode Layer

The negative electrode layer may include, e.g., the current collector and the negative electrode active material layer on the current collector. The negative electrode active material layer may include a negative electrode active material and may further include a binder, a conductive material, or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer on the surface of the core. The crystalline carbon may be artificial graphite, natural graphite, or a combination thereof. As the amorphous carbon precursor, coal pitch, mesophase pitch, petroleum pitch, coal oil, petroleum heavy oil, or polymer resin such as phenol resin, furan resin, and polyimide resin may be used. In an implementation, a content of silicon may be about 10 wt % to about 50 wt % based on a total weight of the silicon-carbon composite. In an implementation, the content of crystalline carbon may be about 10 wt % to about 70 wt % based on a total weight of the silicon-carbon composite and the content of amorphous carbon may be about 20 wt % to about 40 wt % based on a total weight of the silicon-carbon composite. In an implementation, a thickness of the amorphous carbon coating layer may be about 5 nm to about 100 nm.

An average particle diameter (D₅₀) of the silicon particle may be about 10 nm to about 20 μm or for example about 10 nm to about 500 nm. The silicon particles may be present in an oxidized form, and an atomic content ratio of Si: O in the silicon particle indicating a degree of oxidation may be about 99:1 to about 33:67. The silicon particles may be SiOₓ particles and the range of x in SiOₓ may be greater than 0 and less than 2. An average particle diameter (D₅₀) may be measured by a microscope image or a particle size analyzer, and may mean a diameter of particles having a cumulative volume of 50 volume % in a particle size distribution.

The Si negative electrode active material or Sn negative electrode active material may be mixed with the carbon negative electrode active material. A mixing ratio of the Si negative electrode active material or Sn negative electrode active material with the carbon negative electrode active material may be a weight ratio of about 1:99 to about 90:10.

A content of the negative electrode active material in the negative electrode active material layer may be about 95 wt % to about 99 wt %, based on a total weight of the negative electrode active material layer.

In an implementation, the negative electrode active material layer may further include the binder and may optionally include the conductive material. A content of the binder in the negative electrode active material layer may be about 1 wt % to about 5 wt % based on a total weight of the electrode active material layer. In an implementation, the conductive material may be further included, and the negative electrode active material layer may include about 90 wt % to about 98 wt % of the negative electrode active material, about 1 wt % to about 5 wt % of the binder, and about 1 wt % to about 5 wt % of the conductive material.

The binder may well adhere the negative electrode active material particles to each other and may also adhere the negative electrode active material to the current collector. The binder may include a water-insoluble binder, a water-soluble binder, or a combination thereof.

The water-insoluble binder may include, e.g., polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may be a rubber binder or a polymer resin binder. The rubber binder may include a styrene-butadiene rubber, an acrylated styrene-butadiene rubber, an acrylonitrile-butadiene rubber, an acryl rubber, a butyl rubber, a fluorine rubber, or a combination thereof. The polymer resin binder may include polyethyleneoxide, polyvinylpyrrolidone, polyepichlorohydrin, polyphosphazene, polyacrylonitrile, ethylenepropylenedienecopolymer, polyvinylpyridine, chlorosulfonatedpolyethylene, latex, a polyester resin, an acrylic resin, a phenol resin, an epoxy resin, polyvinyl alcohol, or a combination thereof.

In an implementation, a water-soluble binder may be used as the negative electrode layer binder, a thickener capable of imparting viscosity may be used together, and the thickener may include, e.g., a cellulose compound. The cellulose compound may include carboxymethyl cellulose, hydroxypropylmethyl cellulose, methyl cellulose, an alkali metal salt thereof, or a combination thereof. The alkali metal may be Na, K, or Li. An amount of the thickener used may be about 0.1 parts by weight to about 3 parts by weight based on 100 parts by weight of the negative electrode active material.

The conductive material may impart conductivity to the electrode, and may include, e.g., a carbon material such as natural graphite, artificial graphite, carbon black, acetylene black, ketjen black, a carbon fiber, a carbon nanotube, or the like; a metal material of a metal powder or a metal fiber including copper, nickel, aluminum, silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode layer may be a precipitation-type negative electrode layer. The precipitation-type negative electrode layer may be a negative electrode layer which has no negative electrode active material during the assembly of a battery but in which a lithium metal and the like are precipitated during the charge of the battery and serve as a negative electrode active material.

FIG. 8 is a schematic cross-sectional view including the precipitation-type negative electrode layer. Referring to FIG. 8 the precipitation-type negative electrode layer 400′ may include a negative electrode current collector 401 and a negative electrode coating layer 405 on the current collector. The all-solid-state battery having this precipitation-type negative electrode layer 400′ starts to be initially charged in absence of a negative electrode active material, and a lithium metal with high density and the like may be precipitated between the negative electrode current collector 401 and the negative electrode coating layer 405 during the charge and may form a lithium metal layer 404, which may work as a negative electrode active material. Accordingly, the precipitation-type negative electrode layer 400′, in the all-solid-state battery which is more than once charged, may include the negative electrode current collector 401, the lithium metal layer 404 on the current collector, and the negative electrode coating layer 405 on the lithium metal layer 404. The lithium metal layer 404 may be a layer of the lithium metal and the like precipitated during the charge of the battery and may be called to be a metal layer, a negative electrode active material layer, or the like.

The negative electrode coating layer 405 may include a lithophilic metal that acts as a catalyst, a carbon material, or a combination thereof.

The metal may include, e.g., gold, platinum, palladium, silicon, silver, aluminum, bismuth, tin, zinc, or a combination thereof, and may be composed of one of these or various types of alloys. When the metal exists in particle form, its average particle diameter (D₅₀) may be less than or equal to about 4 μm or, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode coating layer 405 may include the metal and the carbon material, and the metal and the carbon material may be, e.g., mixed in a weight ratio of about 1:10 to about 2:1. Herein, the precipitation of the lithium metal may be effectively promoted and improve characteristics of the all-solid-state battery. The negative electrode coating layer 405 may include, e.g., a carbon material on which a catalyst metal is supported or a mixture of metal particles and carbon material particles.

The negative electrode coating layer 405 may include, e.g., the metal and amorphous carbon, and in this case, the deposition of lithium metal may be effectively promoted.

The negative electrode coating layer 405 may further include the binder and the binder may be the conductive binder. In an implementation, the negative electrode coating layer 405 may further include an additive, e.g., a filler, a dispersant, or an ionic conductive agent.

A thickness of the negative electrode coating layer 405 may be, e.g., about 100 nm to about 20 μm, about 500 nm to about 10 μm, or about 1 μm to about 5 μm.

The precipitation-type negative electrode layer 400′ may further include a thin film on the surface of the current collector, e.g., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may help further planarize a precipitation shape of the lithium metal layer 404 and may help improve characteristics of the all-solid-state battery. The thin film may be formed by, e.g., vacuum deposition, sputtering, or plating methods. A thickness of the thin film may be, e.g., about 1 nm to about 500 nm.

The all-solid-state rechargeable battery may be a unit cell having a structure of a positive electrode layer/solid electrolyte membrane/negative electrode layer, a bicell having a structure of a negative electrode layer/solid electrolyte membrane/positive electrode layer/solid electrolyte membrane/negative electrode layer, or a stacked battery in which the unit battery structure is repeated.

In an implementation, the shape of the all-solid-state rechargeable battery may be, e.g., coin-shaped, button-shaped, sheet-shaped, stacked-shaped, cylindrical, flat, etc. In an implementation, the all-solid-state battery may also be applied to large batteries used in electric vehicles, etc. In an implementation, the all-solid-state rechargeable battery may also be used in hybrid vehicles such as plug-in hybrid electric vehicles (PHEV). In an implementation, it may be used in a field requiring a large amount of power storage, and may be used, for example, in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Preparation of Composite

As diamagnetic particles, needle-shaped artificial graphite with an aspect ratio: 4.0, a minor axis length: 1 μm, and a major axis length: 4 μm was prepared. In addition, Li₂S, P₂S₅, and LiCl as raw materials for a solid electrolyte, were mixed in a mole ratio of 5:1:2. The solid electrolyte raw material mixture and the diamagnetic particles were mixed in a weight ratio of 30:1 in a solvent of acetonitrile and then, magnetically stirred for 2 hours, dried at 120° C., and heat-treated at 400° C. Accordingly, a solid electrolyte composite including a core containing the needle-shaped artificial graphite; and a shell including the Li₆PS₅Cl solid electrolyte surrounding the core was obtained.

### (2) Preparation of Slurry for Forming Second Layer

20 wt % of the composite, 78.3 wt % of the Li₆PS₅Cl solid electrolyte particles (D₅₀=3 μm) as argyrodite-type crystals, 1.3 wt % of an acryl binder (SX-A334, Zeon Co., Ltd.), and 0.4 wt % of a dispersant (H-NBR) were added under a solvent of octyl acetate and then, mixed with a Thinky mixer to prepare a slurry for a second layer.

### (3) Manufacture of First Layer

An acryl binder (SX-A334, Zeon Co., Ltd.) was added to octyl acetate to prepare an acryl binder solution with 4 wt % of the binder. The acryl binder solution was added to the Li₆PS₅Cl solid electrolyte particles (D₅₀=3 μm), argyrodite-type crystals, and then, mixed with the Thinky mixer to prepare a slurry. The slurry included 1.5 parts by weight of the acryl binder based on 98.5 parts by weight of the solid electrolyte. The prepared slurry was coated on a non-woven fabric with a bar coater and dried at 50° C. in a convection oven for 5 minutes, obtaining a stack.

### (4) Manufacture of Second Layer

The prepared slurry for forming a second layer was applied on the above first layer by using a bar coater, and a magnetic field was applied thereto at strength of 1 T for 2 minutes at 25° C. After applying the magnetic field thereto, the slurry to which the magnetic field was applied was dried at 50° C. in a convection oven for 5 minutes. Through the above process, a stack having a second layer formed on the first layer was manufactured.

### (5) Manufacture of Third Layer

Subsequently, an acryl binder (SX-A334, Zeon Co., Ltd.) was added to octyl acetate to prepare an acryl binder solution with 4 wt % of the binder. The acryl binder solution was added to the Li₆PS₅Cl solid electrolyte particles (D₅₀=3 μm), argyrodite-type crystals and then, mixed with a Thinky mixer to prepare slurry for a third layer. The slurry for a third layer included 1.5 parts by weight of the acryl binder based on 98.5 parts by weight of the solid electrolyte. The prepared slurry for a third layer was coated on the second layer with a bar coater and then, dried at 50° C. in a convection oven for 5 minutes, obtaining a stack having first layer-second layer-third layer in order.

Subsequently, the stack was dried at 80° C. in a vacuum oven for 2 hours or more, manufacturing a solid electrolyte membrane.

### (6) Manufacture of Positive Electrode Layer

A positive electrode slurry was prepared by using octyl acetate as a solvent and mixing 13.5 wt % of a Li₆PS₅Cl solid electrolyte (D₅₀=3 μm), argyrodite-type crystals, 85 wt % of a positive electrode active material (LiNi_{0.8}Co_{0.1}Al_{0.1}O₂), 1.0 wt % of a PVDF binder, and 0.5 wt % of carbon nanotube. The positive electrode slurry was coated on one surface of an aluminum foil positive electrode current collector and then dried and compressed to manufacture a positive electrode.

### (7) Manufacture of Negative Electrode Layer

As a negative current collector, a 12.5 μm-thick nickel foil was prepared. In addition, as a material for forming a negative electrode coating layer, carbon black (CB) with a D₅₀ particle diameter of about 30 nm and silver (Ag) particles with a D₅₀ particle diameter of about 60 nm were prepared.

The carbon black (CB) and the silver (Ag) particles were mixed in a weight ratio of 3:1 to form a mixed powder, and after adding 0.25 g of the mixed powder to a container, 2 g of a NMP solution including 7 wt % of a PVDF binder (#9300, Kureha Corp.) was added thereto, preparing a mixed solution. Subsequently, the mixed solution was stirred, while NMP was added thereto little by little, preparing a slurry. The prepared slurry was coated on a nickel foil with a bar coater and dried at 80° C. in a convection oven for 10 minutes, obtaining a stack. The obtained stack was vacuum-dried at 100° C. for 8 hours or more, that is, for 10 hours. Through the aforementioned process, a negative electrode layer, in which a negative electrode coating layer was formed on the negative current collector, was manufactured.

(6) Manufacture of All-solid-state Rechargeable Battery

The solid electrolyte membrane was disposed between the positive electrode layer and the negative electrode layer to prepare a stack. The prepared stack was hot plate-pressed at 80° C. for 30 minutes at a pressure of 500 MPa, manufacturing an all-solid-state rechargeable battery cell. Through this pressure treatment, the solid electrolyte membrane was sintered, improving battery characteristics. The pressed positive electrode active material layer had a thickness of about 103 μm, the negative electrode coating layer had a thickness of 7 μm, and the solid electrolyte membrane had a thickness of 60 μm.

Additionally, the solid electrolyte membrane, in which the first layer, the second layer, and the third layer in order were stacked, was prepared into a cross-section specimen, and an image thereof was captured with a scanning electron microscope (SEM). When measured with SEM, the first layer had an average thickness of 30 μm, the second layer had an average thickness of 60 μm, and the third layer had an average thickness of 30 μm. Herein, each average thickness of the first layer, the second layer, and the third layer was obtained by measuring a thickness at any ten points at equal intervals and calculating their average value.

In the cross-section specimen, 10 composites in the second layer were randomly selected to measure each shell thickness of the composites and then, calculate an average shell thickness, which was 0.5 μm.

### Comparative Example 1

A solid electrolyte membrane and an all-solid-state rechargeable battery cell were manufactured substantially in the same manner as in Example 1 except that the solid electrolyte membrane was formed as a monolayer including solid electrolyte particles (Li₆PS₅Cl) alone instead of the triple layered one.

### Comparative Example 2

A solid electrolyte membrane and an all-solid-state rechargeable battery cell were manufactured substantially in the same manner as in Example 1 except that the slurry for a second layer was prepared only by using needle-shaped artificial graphite with an aspect ratio: 4.0, a minor axis length: 1 μm, and a major axis length: 4 μm (without forming the shell), instead of the composite.

### Comparative Example 3

A solid electrolyte membrane and an all-solid-state rechargeable battery cell were manufactured substantially in the same manner as in Example 1 except that the composite was prepared by using needle-shaped artificial graphite with an aspect ratio: 1.0, a minor axis length: 3.5 μm, and a major axis length: 3.5 μm, without forming the shell.

For reference, Table 1 shows structures of the solid electrolytes (or composite) of Example 1 and Comparative Examples 1 to 3, structures of the solid electrolyte membranes, shapes of the diamagnetic particles, aspect ratios of the diamagnetic particles, minor and major axis lengths of the diamagnetic particles, and a core and shell weight ratios of the composite.

TABLE 1

| | | | | | | | | | Weight |
|---|---|---|---|---|---|---|---|---|---|
| | | Solid | Diamagnetic particles | | | | | | ratio of |
| | Structure of solid | electrolyte | | | Minor | | Major | | core:solid |
| | electrolyte | membrane | | aspect | axis | | axis | | electrolyte |
| | (or composite) | structure | Shape | ratio | length | | length | | shell |
| Example 1 | diamagnetic particles | triple layer | needle- | 4.0 | 1 | μm | 4 | μm | 1:30 |
| | core-solid electrolyte | | shaped | | | | | | |
| | shell | | | | | | | | |
| Comparative | solid electrolyte | monolayer | irregular | — | — | | — | | — |
| Example 1 | alone | | shaped | | | | | | |
| Comparative | diamagnetic particles | triple layer | needle- | 4.0 | 1 | μm | 4 | μm | — |
| Example 2 | alone | | shaped | | | | | | |
| Comparative | diamagnetic particles | triple layer | spherical | 1.0 | 3.5 | μm | 3.5 | μm | — |

| | | |
|---|---|---|
| Example 3 | alone | shape |

### Evaluation Example 1: Ionic Conductivity of Positive Electrode Layer

Each of the solid electrolyte membranes of the Example and the Comparative Examples was evaluated with respect to ionic conductivity.

Each of the solid electrolyte membranes of the Example and the Comparative Examples was placed in a mold with a diameter of 10 mm and then, pressed at a pressure of 350 mPa into a pellet. On both sides of the pellet, an indium (In) thin film was coated to prepare a sample for measuring the ionic conductivity. The sample was measured with respect to impedance by using AUTOLAB PGSTAT30 (Metrohm Autolab Co. Ltd.), a potentiostat, to draw a Nyquist plot, from which the ionic conductivity at 45° C. was measured. The results are shown in Table 2 below.

TABLE 2

| | Ionic conductivity (mS/cm) (@ 45° C.) |
|---|---|
| Example 1 | 0.41 |
| Comparative Example 1 | 0.34 |
| Comparative Example 2 | 0.4 |
| Comparative Example 3 | 0.32 |

Referring to Table 2, the solid electrolyte membrane of Example 1 exhibited higher ionic conductivity than the solid electrolyte membranes of Comparative Examples 1 to 3.

In Example 1, the solid electrolyte membrane was manufactured by using a composite with a core-shell structure including a core including diamagnetic particles with an aspect ratio of greater than 1; and a shell surrounding the core and including a solid electrolyte. Accordingly, as a magnetic field was applied to the manufacturing process of Example 1, the composite was aligned within a range of 50° to 130° with a plane direction of the solid electrolyte membrane in the second layer 12 of the solid electrolyte membrane. The alignment of the composite was checked by manufacturing a cross-section specimen of the solid electrolyte membrane, and an image thereof was captured with a scanning electron microscope (SEM) to measure an alignment angle of 10 composites and calculate their average value. In the above solid electrolyte membrane, the composites were aligned, a lithium ion path was shortened in the solid electrolyte membrane according to Example 1, and high ionic conductivity was secured.

On the contrary, Comparative Example 1 was a case of using a monolayered solid electrolyte membrane instead of the triple layered solid electrolyte membrane of Example 1 and an amorphous solid electrolyte itself instead of the composite of Example 1. Accordingly, during the manufacturing the solid electrolyte membrane of Comparative Example 1, even though a magnetic field was applied thereto, the amorphous solid electrolyte in the solid electrolyte membrane was not specifically, but rather randomly aligned.

Comparative Example 2 was a case of using needle artificial graphite alone without the solid electrolyte shell instead of the composite in the second layer of Example 1. Accordingly, although a magnetic field was applied during the manufacturing process of the solid electrolyte membrane according to Comparative Example 2, the needle-shaped artificial graphite having no solid electrolyte shell was almost vertically aligned in the second layer of the solid electrolyte membrane. However, in Comparative Example 2, the solid electrolyte shell was not formed, and there was an issue of battery safety in Evaluation Example 2, as explained in greater detail below.

On the other hand, in the solid electrolyte membrane of Comparative Example 3, even though a magnetic field was applied thereto, the composite exhibited no alignment. Accordingly, compared with Comparative Example 1, there was no ionic conductivity increase effect.

### Evaluation Example 2: Evaluation of High Rate Capability and Internal Short Circuit Occurrence of All-solid-state Rechargeable Battery

For each all-solid-state rechargeable battery of the Example and Comparative Examples, high-rate characteristics were evaluated.

The all-solid-state rechargeable battery cells of the Example and Comparative Examples were charged under constant current to 4.25 V at 0.1 C and discharged under constant current to 2.5 V at 0.1 C (first cycle); charged under constant current to 4.25 V at 0.1 C and discharged under constant current to 2.5 V at 0.33 C (second cycle); charged under constant current to 4.25 V at 0.1 C and discharged under constant current to 2.5 V at 0.1 C (third cycle) at 45° C. in a thermostat to evaluate discharge capacity and high rate capability.

The discharge capacity and high rate capability at each cycle are shown in Table 3. Herein, the high rate capability was defined according to Equation 4.

High rate capability [%]=[Discharge capacity in the 3rd cycle (1C rate)/Discharge capacity in the 1st cycle(0.1C rate)]×100[%] [Equation 4]

In addition, at the above charge and discharge cycles, when no internal short circuit occurred, ‘X’ was given, but when an internal short circuit occurred, ‘O’ was given, and the results are shown in Table 3.

TABLE 3

| | 0.1 C | 0.33 C | 1 C | High | Internal |
|---|---|---|---|---|---|
| | discharge | discharge | discharge | rate | Short |
| | capacity | capacity | capacity | capability | Circuit |
| | (mAh/g) | (mAh/g) | (mAh/g) | (%) | Occurrence |
| Example 1 | 197 | 184 | 172 | 87.3 | X |
| Comparative | 195 | 183 | 168 | 86.2 | X |
| Example 1 | | | | | |
| Comparative | — | — | — | — | ◯ |
| Example 2 | | | | | |
| Comparative | — | — | — | — | ◯ |
| Example 3 | | | | | |

Referring to Table 3, Example 1, compared with Comparative Examples 1 to 3, exhibited excellent high rate capability as well as excellent discharge capacity at each cycle and no internal short circuit. Accordingly, the solid electrolyte membrane was formed as a triple layer by using the composite as shown in Example 1, high rate capability of an all-solid-state rechargeable battery cell was improved, and there was an effect of suppressing an internal short circuit.

On the contrary, the cell of Comparative Example 1 exhibited no internal short circuit but as confirmed in Evaluation Example 1, low ionic conductivity, and the cells of Comparative Examples 2 and 3 exhibited an internal short circuit.

By way of summation and review, lithium ion batteries currently on the market may use an electrolyte solution, which includes a flammable organic dispersive medium, and if a short circuit were to occur inside the batteries, overheating or fire could occur. Accordingly, an all-solid rechargeable battery may use a solid electrolyte instead of an electrolyte solution.

One or more embodiments may provide a solid electrolyte membrane capable of improving the ionic conductivity and high rate capability of an all-solid-state rechargeable battery while ensuring battery safety.

A solid electrolyte membrane and an all-solid rechargeable battery including the same according to some embodiments may help improve ionic conductivity and high rate characteristics while ensuring battery safety.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte membrane, comprising:
a first layer including solid electrolyte particles;
a second layer on the first layer, the second layer comprising a composite; and
a third layer on the second layer, the third layer comprising solid electrolyte particles,
wherein the composite comprises:
a diamagnetic core particle, and
a shell surrounding the diamagnetic core particle, the shell comprising a solid electrolyte material.

2. The solid electrolyte membrane as claimed in claim 1, wherein the diamagnetic core particle has an aspect ratio greater than 1, as calculated by Equation 1:
aspect ratio=major axis length/minor axis length [Equation 1].

3. The solid electrolyte membrane as claimed in claim 2, wherein a major axis of the composite is arranged at about 50° to about 130° with respect to a plane direction of the solid electrolyte membrane.

4. The solid electrolyte membrane as claimed in claim 1, wherein the composite comprises the diamagnetic core particle and the shell at a weight ratio of about 1:1 to about 1:500.

5. The solid electrolyte membrane as claimed in claim 1, wherein the diamagnetic core particle is needle-shaped, plate-shaped, or oval-shaped.

6. The solid electrolyte membrane as claimed in claim 1, wherein the diamagnetic core particle comprises a carbon material, the carbon material comprising artificial graphite, natural graphite, graphene, a carbon nanotube, a carbon fiber, carbon black, or a combination thereof.

7. The solid electrolyte membrane as claimed in claim 1, wherein the shell comprises a sulfide solid electrolyte, an oxide solid electrolyte, a halide solid electrolyte, or a combination thereof.

8. The solid electrolyte membrane as claimed in claim 1, wherein:
the composite satisfies one or more of Equations 2 and 3:
0.1≤A₁/B≤100[Equation 2]
0.01≤A₂/B≤10[Equation 3]
in Equations 2 and 3, A1 represents a major axis length of the diamagnetic core particle, A2 represents a minor axis length of the diamagnetic core particle, and B represents a thickness of the shell.

9. The solid electrolyte membrane as claimed in claim 1, wherein the second layer further comprises solid electrolyte particles.

10. The solid electrolyte membrane as claimed in claim 9, wherein a content of the solid electrolyte particle in the second layer is about 50 wt % to about 99.9 wt %, based on a total weight of the second layer.

11. The solid electrolyte membrane as claimed in claim 1, wherein:
a major axis length of the diamagnetic core particle is about 1 μm to about 50 μm, and
a minor axis length of the diamagnetic core particle is about 10 nm to about 5 μm.

12. The solid electrolyte membrane as claimed in claim 1, wherein the composite is included in the second layer in an amount of about 0.1 wt % to about 50 wt %, based on a total weight of the second layer.

13. The solid electrolyte membrane as claimed in claim 1, wherein:
an average thickness of the first layer is about 10 μm to about 200 μm, and
an average thickness of the third layer is about 10 μm to about 200 μm.

14. The solid electrolyte membrane as claimed in claim 1, wherein:
an average thickness of the second layer is greater than an average thickness of the first layer, and
the average thickness of the second layer is greater than an average thickness of the third layer.

15. The solid electrolyte membrane as claimed in claim 1, wherein:
an average thickness of the second layer is in a range of about 1.2 times to about 5 times an average thickness of the first layer, and
the average thickness of the second layer is in a range of about 1.2 times to about 5 times an average thickness of the third layer.

16. The solid electrolyte membrane as claimed in claim 1, wherein:
an average thickness of the first layer is about 10 μm to about 34 μm,
an average thickness of the second layer is about 35 μm to about 100 μm, and
an average thickness of the third layer is about 10 μm to about 34 μm.

17. The solid electrolyte membrane as claimed in claim 1, wherein:
the second layer further comprises a binder, and
the binder is included in the second layer in an amount of about 0.1 wt % to about 3 wt %, based on a total weight of the second layer.

18. The solid electrolyte membrane as claimed in claim 1, wherein the solid electrolyte particles comprise sulfide solid electrolyte particles.

19. A method of preparing a solid electrolyte membrane, the method comprising:
forming a first layer including solid electrolyte particles,
forming a second layer on the first layer such that the second layer comprises a composite, and
forming a third layer on the second layer such that the third layer comprises solid electrolyte particles,
wherein the composite comprises:
a diamagnetic core particle, and
a shell surrounding the diamagnetic core particle, the shell comprising a solid electrolyte.

20. The method of preparing the solid electrolyte membrane as claimed in claim 19, wherein forming the second layer comprises:
preparing the composite such that the composite comprises the diamagnetic core particle; and the shell surrounding the diamagnetic core particle and comprising a solid electrolyte,
preparing a slurry for forming the second layer comprising the composite, and
coating the slurry for forming the second layer on the first layer.

21. The method of preparing the solid electrolyte membrane as claimed in claim 20, further comprising applying a magnetic field to the slurry for forming the second layer coated on the first layer.

22. The method of preparing the solid electrolyte membrane as claimed in claim 21, further comprising drying the slurry for forming the second layer after the magnetic field has been applied.

23. The method of preparing the solid electrolyte membrane as claimed in claim 19, wherein preparing the composite comprises:
mixing the diamagnetic core particle, the solid electrolyte, and a first solvent to prepare a mixed solution,
drying the mixed solution to form a dried product, and
heat-treating the dried product.

24. The method of preparing the solid electrolyte membrane as claimed in claim 20, wherein preparing the slurry for forming the second layer comprises mixing the composite and a second solvent.

25. The method of preparing the solid electrolyte membrane as claimed in claim 21, wherein a magnetic field strength is about 0.1 T to about 3 T.

26. The method of preparing the solid electrolyte membrane as claimed in claim 21, wherein an application time of the magnetic field is about 0.1 second to about 10 minutes.

27. The method of preparing the solid electrolyte membrane as claimed in claim 19, further comprising:
drying the first layer;
drying the second layer;
drying the third layer; and
drying a stack of the first layer, the second layer, and the third layer after drying the third layer,
wherein a drying temperature for drying the stack is higher than a drying temperature for drying each of the first layer, second layer, and third layer.

28. The method of preparing the solid electrolyte membrane as claimed in claim 27, wherein drying the stack is performed at about 70° C. to about 120° C.

29. An all-solid-state rechargeable battery, comprising:
a positive electrode layer;
a negative electrode layer; and
the solid electrolyte membrane as claimed in claim 1 between the positive electrode layer and the negative electrode layer.

30. The all-solid-state rechargeable battery as claimed in claim 29, wherein:
the negative electrode layer comprises a negative electrode current collector; and a negative electrode coating layer on the negative electrode current collector and comprising a lithophilic metal, a carbon material, or a combination thereof, and
a lithium metal layer is formed by charging between the negative electrode current collector and the negative electrode coating layer.
